(19) United States
(12) Patent Application Publication
(10) Pub. No.: US 2023/0327990 A1
(43) Pub. Date: Oct. 12, 2023

(54) TRANSFER SYSTEM, TRANSFER DEVICE, TRANSFER CONTROL DEVICE, AND PROGRAM

(71) Applicant: Nippon Telegraph and Telephone Corporation, Tokyo (JP)

(72) Inventors: Takayoshi HIRASAWA, Musashino-shi, Tokyo (JP); Satoshi NAKATSUKASA, Musashino-shi, Tokyo (JP); Ken TAKAHASHI, Musashino-shi, Tokyo (JP)

(21) Appl. No.: 18/022,693

(22) PCT Filed: Aug. 25, 2020
(86) PCT No.: PCT/JP2020/031936

§ 371 Date: Feb. 22, 2023

(51) Int. Cl. H04L 45/00; H04L 43/0864

(52) U.S. Cl. CPC H04L 45/70; H04L 43/0864

(57) ABSTRACT

A transfer device is capable of outputting packets to a plurality of physical lines, and includes a measurement unit configured to measure performance of network requirements specified by a given service for each physical line; and a selection unit configured to select the physical line at which the measured performance is maximized from among the plurality of physical lines. A transfer control device includes an instruction unit configured to receive an advertisement including route information for selecting a route for each network requirement from a transfer device that outputs packets to a plurality of physical lines, and to offer a route instruction using the route information to a service for which the requirement is specified.

### TECHNICAL FELD

The present invention relates to a transfer system, a transfer device, a transfer control device, a transfer method and a program.

### BACKGROUND ART

In recent years, the technology for controlling a transfer route such as segment routing (SR) has been actively developed. For example, NPL 1 discloses a technology that is useful for transfer route control by measuring a latency time in a network (NW) and implementing highly accurate detection of latency fluctuations.

### CITATION LIST

### Non Patent Literature

[NPL 1] Hiroki Mori et al., “Proposal of High Accuracy Delay Measurement System”, IEICE Technical Report, Vol. 119, No. 460, NS2019-231, pp. 301-306, March 2020.

### SUMMARY OF INVENTION

### Technical Problem

In order to meet various demands for services provided by the network, the scale of network is being expanded and the number of lines in the network is increasing (e.g. link aggregation [LAG]). As recent trends, such as 5G network slicing and e-sports, have led to diversified user cases, now network requirements (hereinafter sometimes referred to as merely “requirement(s)”) include delay and packet loss instead of being limited to a band; broadband, low-latency, or low-packet-loss communication is required. Since these requirements vary depending on traffic status, a huge amount of calculation is required to reflect the measurement results for each requirement in service route control. Considering such situations, controller for route control (transfer control device) has to have extremely heavy lead and performance of the controller is deteriorated, whereby decrease in response speed may be caused.

Therefore, the present invention is intended to reduce stress of a transfer control device for performing route control.

### Solution to Problem

To address the problems stated above, provided is a transfer system according to the present invention which includes a transfer device that outputs packets to a plurality of physical lines; and a transfer control device, in which the transfer device includes: a measurement unit configured to measure performance network requirements specified by a given service for each physical line; and a selection unit configured to select the physical line at which the measured performance is maximized from among the plurality of physical lines, and in which the transfer control device includes: an instruction unit configured to receive an advertisement including route information for selecting a route for each requirement from the transfer device, and to offer a route instruction using the route information to a service for which the requirement is specified.

### Advantageous Effects of Invention

According to the present invention, it is possible to reduce stress of a transfer control device for performing route control.

### BRIEF DESCRIPTION OF DRAWINGS

FIG. 1 is an exemplified overall schematic diagram illustrating a transfer system according to the present embodiment.

FIG. 2 is an exemplified functional configuration diagram illustrating NE.

FIG. 3 is a diagram illustrating an example of route information for each requirement, which is stored in the NE.

FIG. 4 is a diagram illustrating an example of route information for each physical line, which is stored in the NE.

FIG. 5 is an exemplified functional configuration diagram illustrating CTL.

FIG. 6 is a diagram illustrating an example of route information for each requirement, which is stored in the CTL.

FIG. 7 is an exemplified diagram illustrating a BE service.

FIG. 7 is an exemplified diagram illustrating a low-latency service.

FIG. 7 is an exemplified diagram illustrating a latency measurement method.

FIG. 10 is an exemplified flowchart illustrating NE processing.

FIG. 10 is an exemplified flowchart illustrating CTL processing.

FIG. 12 is a hardware configuration diagram illustrating one example of a computer that implements functions of the NE and the CTL.

### DESCRIPTION OF EMBODIMENTS

### <Configuration>

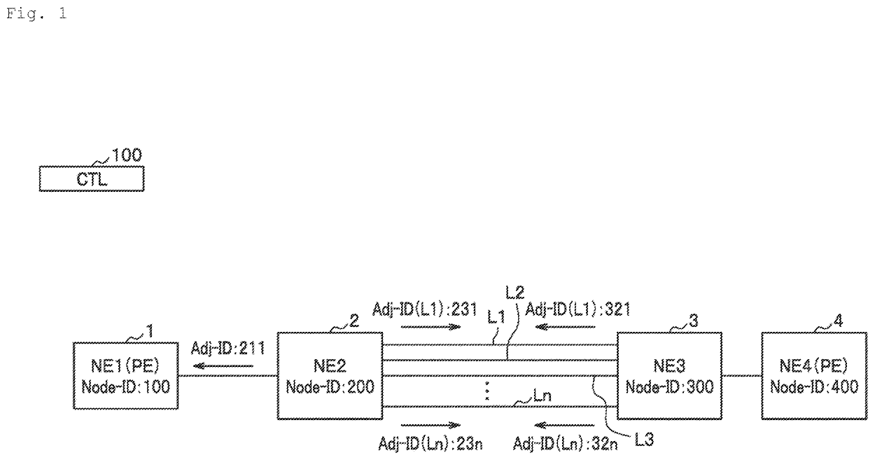

As shown in FIG. 1, the transfer system according to the present embodiment includes network elements (NEs; corresponding to a transfer device) 1 to 4 and a controller (CTL; corresponding to a transfer control device) 100. The NEs 1 to 4 and the CTL 100 are communicably connected.

The NEs to 4 each are a transfer device that transfers packets provided for services. The NEs 1 to 4 are, for example, routers, bridges, and gateways, but are not limited thereto. Node-IDs 100 to 400, which serve as identifiers of the NEs to 4, are assigned to the NEs 1 to 4, respectively.

The NEs and 4 function as provider edges (PEs). The NEs 1 and 2 are connected by a single physical line. For convenience, the physical line may be simply referred to as a “line”. Adj-ID: 211, which serves an identifier of a physical line, is assigned to a physical line between the NE 1 and the NE 2. Adj-ID: 211 can represent a transfer from the NE 2 to the NE 1 (although there is an identifier representing a transfer from the NE 1 to NE 2, but it is not shown in the drawing). The NEs 2 and 3 are connected by physical lines L1 to Ln. Ad-ID: 231 to 23n and 321 to 32n are assigned to the physical lines L1 to Ln between the NEs 2 and 3. Adj-ID: 231 to 23n can represent a transfer from the NE 2 to the NE 3. Adj-ID: 321 to 32n can represent a transfer from the NE 3 to the NE 2. The NEs 3 and 4 are connected by a single physical line. An identifier is assigned to the physical line between the NEs 3 and 4, but it is not shown in the drawing.

The CTL 100 is a transfer control device that controls the NEs 1 to 4. The CTL 100 can control route exchange (exchange of route information) between autonomous systems (ASs) by a border gateway protocol (BGP) using a forwarding information base (FIB) or a router information base (RIB), as a well-known control by segment routing (SR). As one of well-known technologies, the CTL 100 can also monitor the entire network in which the NEs 1 to 4 are arranged and measure the performance of the entire network.

In the present embodiment, a case where a service is provided by the SR using a transfer route (end-to-end [E2E] transfer route) of NE1→NE2→NE3→NE4 will be described. The CTL 100 can control the E2E transfer route for each service. The NE 2 can output a packet to the physical lines L1 to Ln. In the present embodiment, the route information (i.e. Node-ID) for specifying each of the NEs 1 to 4 for route control and the route information (i.e. Adj-ID) for specifying each physical line are advertised in the network.

### (Functional Configuration of NE 2)

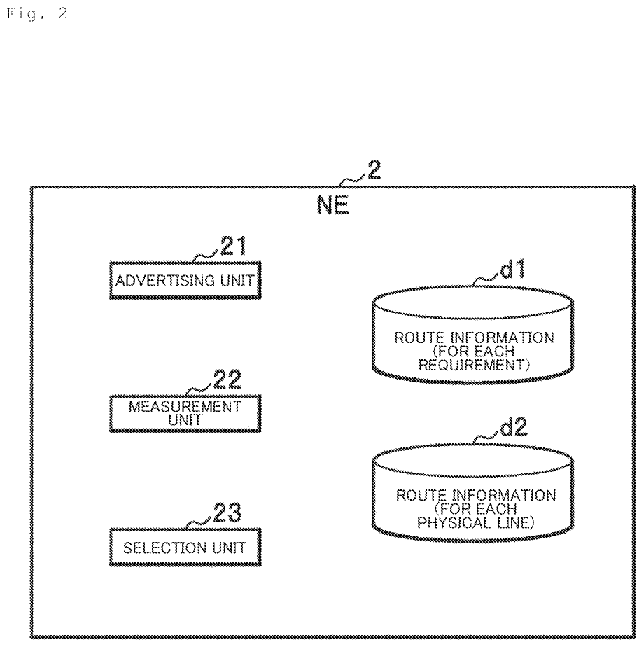

A functional configuration of the NE 2 will be described with reference to FIG. 2. This description also applies to the NEs 1, 3 and 4. The NE 2 includes an advertising unit 21, a measurement unit 22, and a selection unit 23. The NE 2 stores route information d1 and d2.

The advertising unit 21 advises the route information to the CTL 100 and other NEs 1, 3 and 4. In particular, the advertising unit 21 can advertise the route information d1 for preferentially selecting, a route for each network requirement to the CTL 100. The requirements include, but are not limited to, latency, bandwidth, and packet loss.

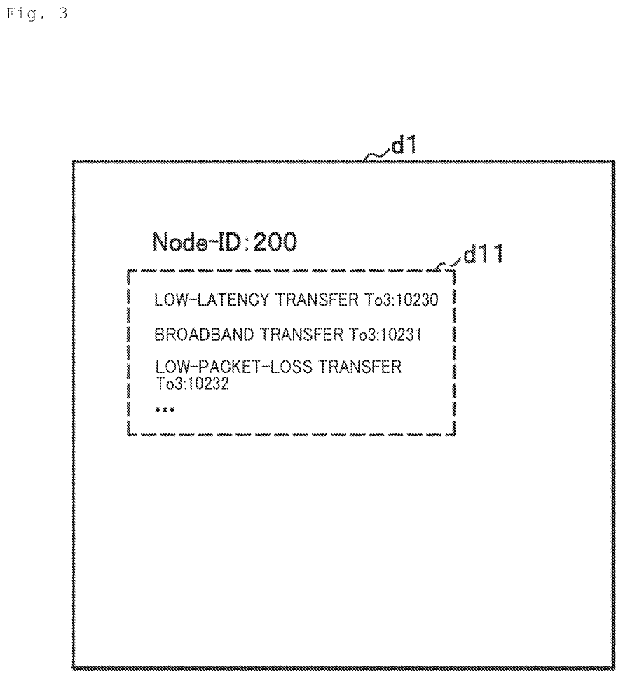

As shown in FIG. 3, the route information d1 advertised by the NE 2 to the CTL 100 includes an information cluster d11 in which a transfer method satisfying the requirements, a transfer destination, and an identifier are associated with each other. The identifier is given to a header of a packet to be transferred, and has a function of specifying a route for each line to the adjacent devices (NEs 1 and 3 for NE 2). In the information cluster d11, “low-latency transfer To3: 10230” indicates that an identifier for low-latency transfer from the NE 2 to the NE 3 is 10230. Further, “broadband transfer To3: 10231” indicates that an identifier for broadband transfer from the NE 2 to the NE 3 is 10231. Moreover, “low-packet-loss transfer To3: 10232” indicates that an identifier for low-packet-lost transfer from the NE 2 to the NE 3 is 10232.

The NE 2 does not advertise the route information d1 to the adjacent devices NE 1 and NE 3. The NE2 can use Node-ID: 300 or the NE 3 when transferring a packet to the NE 3 without any requirement.

Returning to FIG. 2, the measurement unit 22 measures performance for each requirement. In particular, the measurement unit 22 can measure an amount of delay (latency) when transferring a packet from the NE 2 to the NE 3 for each physical line. A method of measuring the latency will be described later. Further, the measurement unit 22 acquires network traffic when transferring a packet from the NE 2 to the NE 3 for each physical line using a traffic counter (not shown) provided by the NE 2, and measures a free bandwidth with respect to a bandwidth of each physical line. The measurement unit 22 can count loss packets when transferring a packet from the NE 2 to the NE 3 for each physical line using the traffic counter (not shown) provided by the NE 2.

The measurement unit 22 updates the route information d2 based on the measurement results. The route information d2 is information for specifying to which physical line of the NE 3 the packet received by NE2 should be transferred. The route information d2 is determined for each physical line.

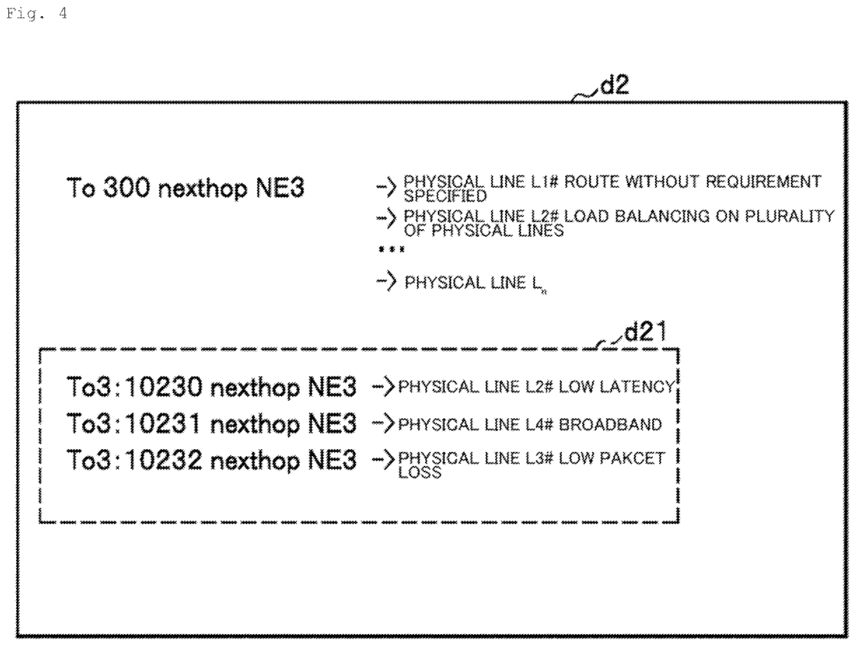

As shown in FIG. 4, the route information d2 includes an information cluster in which an identifier, a transfer destination, and a physical line are associated with each other. The identifier is given to a header of a packet to be transferred, and has a function of specifying a route for each line to the adjacent devices (NEs 1 and 3 for NE 2). In FIG. 4, “To 300 nexthop NE3→physical line L1 # route without requirement specified” indicates that a packet is transferred to the NE 3 identified by Node-ID: 300 via the physical line L1 in a case where the requirement is not specified. The route information for “To 300 nexthop NE3” is the same as before. A phrase following “#” is a comment, which does not affect the information processing of the NE 2 and may be omitted.

When the route information d2 is updated based on the measurement results, the measurement unit 22 adds the information cluster d21 in which the identifier, the transfer destination, and the physical line are associated with each other. In the information cluster d21, “To 10230 nexthop NE3→physical line L2 # low latency” indicates that a packet is forwarded to the NE 3 via the physical line L2 as low-latency transfer in a case where the NE 2 receives a packet containing the identifier “10230” for low-latency transfer. The physical line L2 is a physical line having the minimum latency (maximum performance) among the physical lines L1 to Ln as measured by the measurement unit 22. Further, “To 10231 nexthop NE3″physical line L4 # broadband” indicates friar a packet is forwarded to the NE 3 via the physical line L4 as broadband transfer in a case where the NE 2 receives a packet containing the identifier “10231” for broadband transfer. The physical line L4 is a physical line having the largest free bandwidth (maximum performance) among the physical lines 1 to n as measured by the measurement unit 22. Further, “To 10232 nexthop NE3→physical line L3 # low packet loss” indicates that a packet is forwarded to the NE 3 via the physical line L3 as low-packet-loss transfer in a case where the NE 2 receives a packet containing the identifier “10232” for low-packet-loss transfer. The physical line L3 is a physical line having the minimum packet loss (maximum performance) among the physical lines L1 to Ln as measured by the measurement unit 22.

The identifier for low-latency transfer, identifier for broadband transfer, and identifier for low-packet-loss transfer are examples of a “requirement-specified identifier”.

Returning to FIG. 2, in a case where the packet received from the NE 1 is transferred to the NE 3, the selection unit 23 selects a physical line via which the packet passes from among the physical lines L1 to Ln. In a case where the packet received from the NE 1 is a packet for which the requirement is specified, that is, in a case where the packet includes the requirement-specified identifier of the route information d1 advertised to the CTL 100 by the NE 2, the selection unit 23 refers to the route information d2 and selects a physical line associated with the requirement-specified identifier. For example, in a case where the NE 2 receives a packet containing the identifier “10230” for low-latency transfer, the selection unit 23 selects the physical line L2. The NE 2 distributes the packet to the selected physical line L2 and transfers it to the NE 3.

### (Functional Configuration of CTL 100)

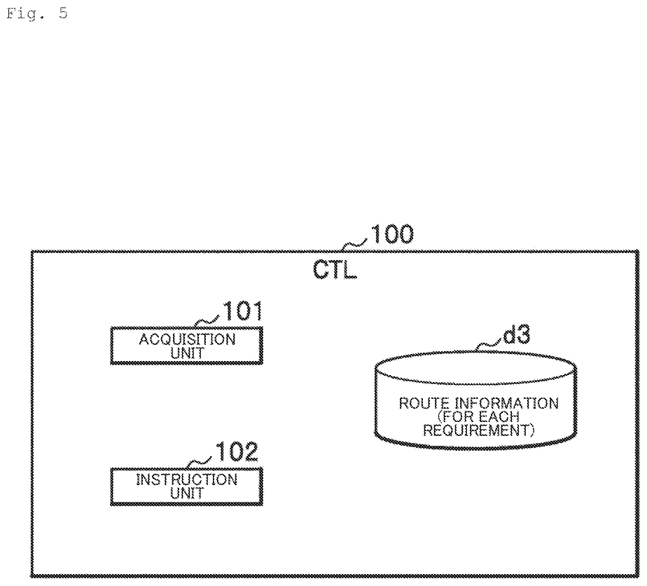

A functional configuration of the CTL 100 will be described with reference to FIG. 5. The CTL 100 includes an acquisition unit 101 and an instruction unit 102. The CTL 100 stores the route information d3.

The acquisition unit 101 acquires a service launch request from a user who uses a service. The service launch request may or may not have a requirement specified. Further, the acquisition unit 101 can acquire not only the service launch request but also a change request (e.g. addition, alteration and removal of requirements) of the service launched.

The instruction unit 102 instructs a transfer route for the service requested by the user. The indication target is the NE 1, which is a starting point of transfer control of an E2E service, but the NEs 2 to 4 may be included. The instruction unit 102 can instruct a transfer route for each service. In a case where a target service is a service for which the requirement is specified, the instruction unit 102 can instruct a transfer route satisfying the requirement to the service. The instruction unit 102 can use the route information d3 when instructing the transfer route.

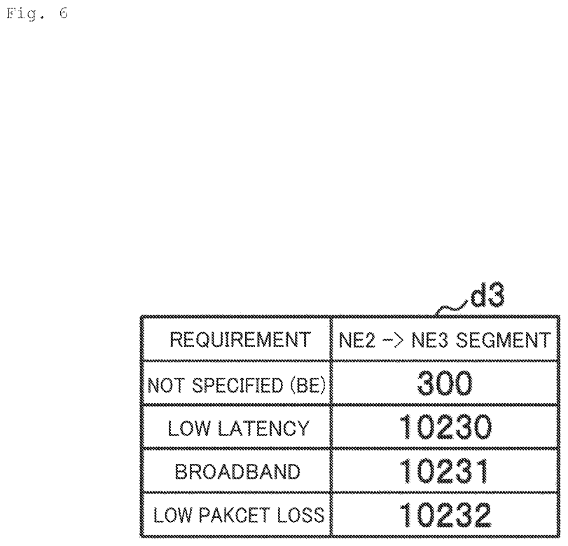

The route information d3 is substantially the same as the route information d1 advertised by the NE 2 to the CTL 100. As shown in FIG. 6, the route information d1 is an information cluster in which a type of requirement is associated with an identifier given to a header of a packet in transfer for a NE2→NE3 segment. In the route information d3, the Node-ID: 300 for the NE 3 is stored, which will be a transfer destination in a case where the requirement not specified (refer to “Not specified (BE)” in FIG. 6). Note that “BE” indicates that route control is performed for a best-effort (BE) service. In FIG. 6, “broadband”, “low latency”, and “low packet loss” represent the requirements for broadband transfer, low-latency transfer, and low-packet-loss transfer, respectively. The route information d3 may include route information for NE segments other than the NE2→NE3 segment.

### (Route Control for BE Service)

In a case where the user requests to launch the BE service for which no requirement is specified, the CTL 100 refers to the route information d3 and reads the Node-ID: 300 of the NE 3. The CTL 100 instructs to the NE 1 an E2E transfer route using the Node-ID: 300 of the NE 3. Such an instruction of the CTL 100 is an instruction of route control according to a protocol for each node as in the conventional technology.

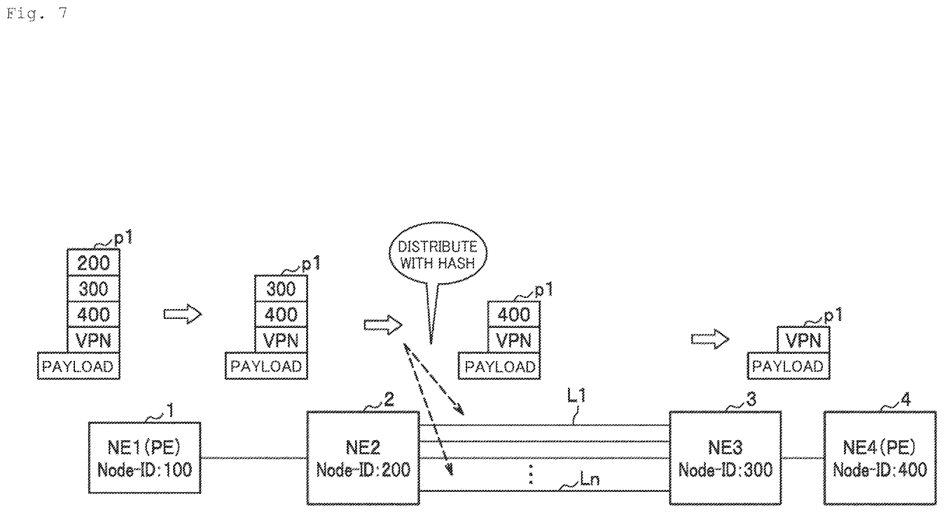

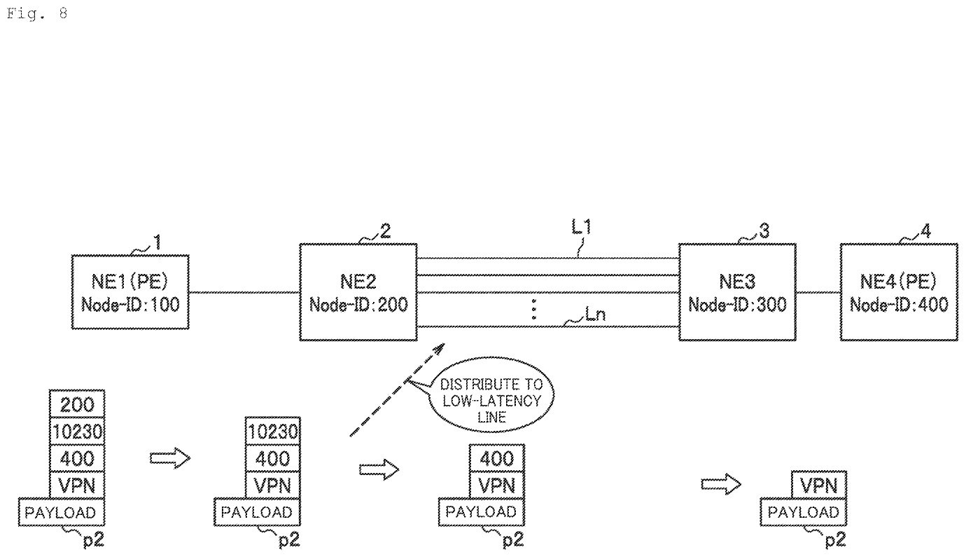

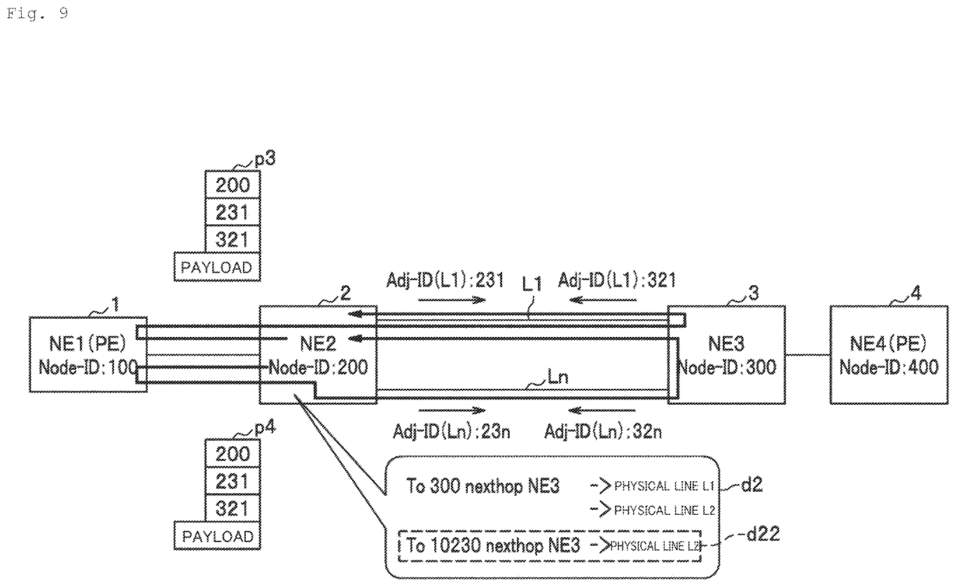

As shown in FIG. 7, the NE 1 generates a packet p1 in response to the instruction from the CTL 100, and transfers the packet p1 by the SR. The packet p1 is constituted by a “200” header, a “300” header, a “400” header, a “VPN” header, and a payload. The “200” header contains the Node-ID: 200 of the NE 2. The “300” header contains the Node-ID: 300 of the NE 2. The “400” header contains the Node-ID: 400 of the NE 2. The “VPN” header is destined for a data center (DC) (not shown). When the NE 2 receives the packet p1 from the NE1, the NE 2 distributes the packet p1 to one of the physical lines L1 to Ln with a hash of the NE 2 and transfers the packet p1 to the NE 3.

### (Route Control for Low-Latency Service)

In a case where the user requests to launch a low-latency service for which latency requirement is specified, the CTL 100 refers to the route information d3 and reads the identifier “10230” for low-latency transfer. The CTL 100 instructs to the NE 1 an E2E transfer route using the identifier “10230”.

As shown in FIG. 8, the NE 1 generates a packet p2 in response to the instruction from the CTL 100, and transfers the packet p2 by the SR. The packet p2 is constituted by a “200” header, a “10230” header, a “400” header, a “VPN” header, and a payload. The “10230” header includes the identifier “10230” for low-latency transfer. The “10230” header serves to indicate a low-latency route.

When the NE2 receives the packet p1 from the NE1, the selection unit 23 selects the physical line L2 (low-latency line) of which latency is determined to be the minimum as measured by the measurement of the measurement unit 22. The NE 2 distributes the packet p1 to the physical line 12 and transfers it to the NE 3.

Therefore, in the transfer control for the service for which the latency requirement is specified, the NE 2 measures performance of each physical line and controls a route of each physical line instead of the CTL 100. Accordingly, the processing previously executed by the CTL 100 is offloaded to the NE 2, and it is possible to reduce the measurement load of the CTL 100 and control load of the CTL 100 due to latency fluctuation. It also applies to a case where the requirement is bandwidth or packet loss.

### (Measurement Method of Latency)

A method of measuring the latency by the measurement unit 22 will be described with reference to FIG. 9. In a case where the transfer with a plurality of physical lines between adjacent NEs as the output side is subject to a load balancing function of the NEs, the measurement unit 22 performs latency measurement for the corresponding line and compares the relative transfer latency. According to FIG. 9, the measurement unit 22 performs measurement on the physical lines L1 to Ln for NE2→NE3.

The NE 2 transits itself and outputs a measurement packet to be transferred to the target physical line. In FIG. 9, the measurement packet is transferred in the order of NE 2→NE 1 (first adjacent transfer device)→NE 2→NE 3 (second adjacent transfer device)→NE 2. The measurement packet p3 is transferred via the physical line L1. The measurement packet p3 includes Adj-ID: 231,321 in the header. The measurement packet p4 is transferred. via the physical line Ln. The measurement packet p4 includes Adj-ID: 23n, 32n in the header. Similar measurement packets are also transferred to the other physical lines L2 to L(n−1). A header is added to the n measurement packets so as to follow the same route except for the physical lines L1 to Ln to be compared.

The measurement unit 22 measures a time from when the measurement packet is transferred to the NE 1 to when the measurement packet is received from the NE 3 for each physical line, and measures the latency. As a result of the measurement, the measurement unit 22 determines a physical line that can implement transfer with relatively lowest latency. In a case where the physical line capable of transfer with relatively lower latency is the physical line L2, a route via the physical line L2 is set as the low-latency transfer route. In particular, the measurement unit 22 registers “To 10230 nexthop NE3→physical line L2” in the route information d2 and updates the route information d2.

### <Processing>

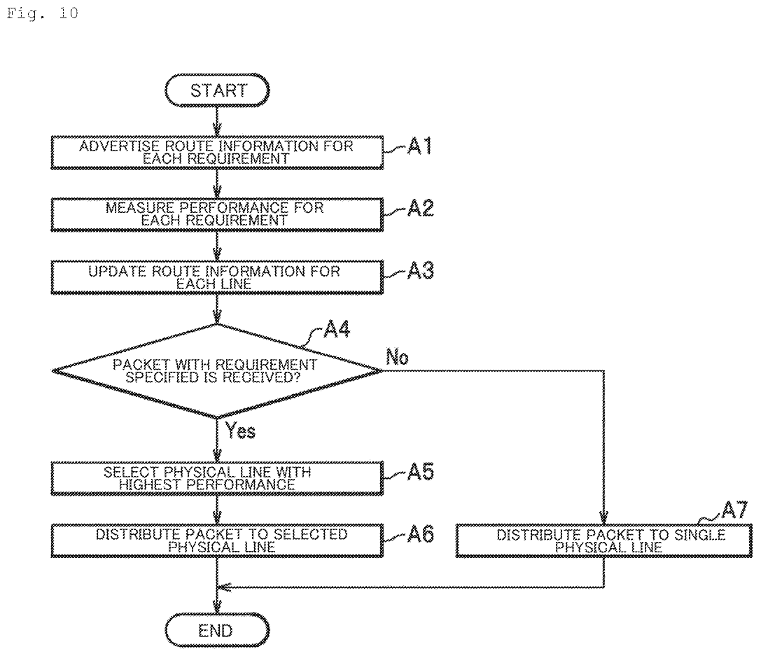

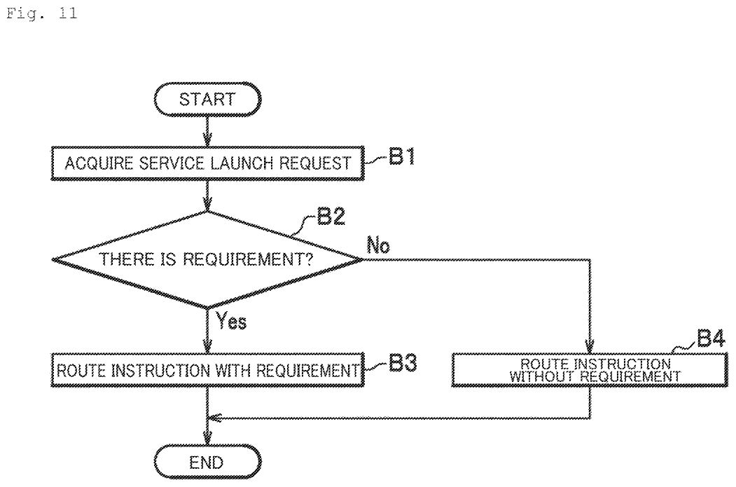

As shown in FIG. 10, the NE2 executes the following processing. The NEs 1, 3 and 4, other than the NE2, can also execute the same processing as long as they are in the same environment as the NE 2 (that is, there are a plurality of physical lines to which packets are output).

First, the advertising unit 21 of the NE 2 advertises the route information d1 (FIG. 3) for each requirement to the CTL 100 (step A1). The measurement unit 22 of the NE 2 measures the performance for each requirement (step A2). The measurement unit 22 of the NE 2 updates the route information d2 for each line based on the measurement results (step A3).

In a case where the CTL 100 instructs the E2E transfer route, the NE2 receives a packet from the NE 1. At this time, in a case where the NE 2 receives a packet for which the requirement is specified (a packet including the requirement-specified identifier) (YES in step A4), the selection unit 23 of the NE 2 selects the physical line having the highest performance for the specified requirement (step AS). The NE 2 distributes the packet to the selected physical line, and the process ends.

On the other hand, in a case where the NE 2 receives a packet for which the requirement is specified (NO in step A4), it indicates that the NE 2 has received a packet without the requirement (a packet that does not include the requirement-specified identifier but the Node-ID: 300). In this case, the NE 2 distributes the packet to one physical line with a hash, and the process ends.

In the processing of FIG. 10, the NE 2 may receive a packet (step A4) before updating the route information d2 (step A3). In this case, the NE 2 selects a physical line according to the route information d2 before the update. In a case where the requirement-specified identifier is not registered in the route information d2 and the NE 2 receives a packet for which the requirement is specified, for example, it is considered that the packet without the requirement is received, and the process proceeds to step A7.

As shown in FIG. 11, the CTL 100 performs the following processing. It is assumed that the CTL 100 stores the route information d3 corresponding to the route information d1 advertised by the NE 2.

The acquisition unit 101 of the CTL 100 acquires a service launch request from a user who uses a service (step B1). The instruction unit 102 of the CTL 100 determines whether or not the requirement is specified in the acquired service launch request (step P2). In a case where the requirement is specified (YES instep B2), the instruction unit 102 gives a route instruction with the requirement to the NE 1 (step B3), and the process ends. The route instruction with the requirement refers to the E2E route instruction for a service which the requirement is specified.

On the other hand, in a case where the requirement is not specified (NO in step B2), the instruction unit 102 instructs a route without requirement (step B3) to the NE 1, and the process ends. The route instruction without requirement refers the E2E route instruction for a service for which the requirement is not specified (e.g. BE service).

### <Hardware Configuration>

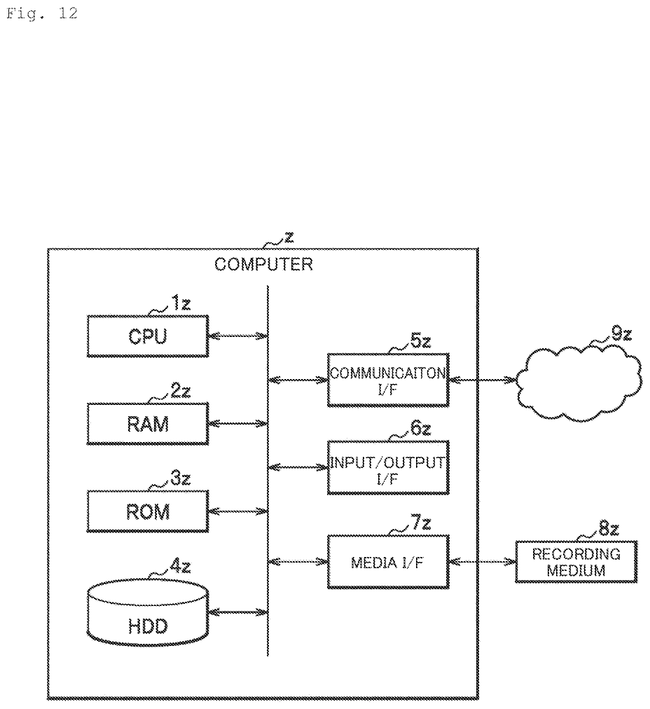

Further, the NEs 1 to 4 and the CTL100 described. above are implemented by, for example, a computer z shown in a hardware configuration as shown in FIG. 12. The computer z has a CPU 1z, a RAM 2z, a ROM 3z, an HDD 4z, a communication I/F (interface) 5z, an input/output I/F 6z, and a media I/F 7z.

The CPU 1z operates based on a program stored in the ROM 3z or the HDD 4z, and controls each unit (advertising unit 21, measurement unit 22, selection unit 23, acquisition unit 101 and instruction unit 102). The ROM 3z stores a boot program executed by the CPU 1z when the computer z is activated, a program related to the hardware of the computer z, and the like.

The HDD 4z stores programs executed by the CPU 1z, data used by the programs, and the like. The communication I/F 5z receives data from other devices via a communication. network 9z, sends the data to the CPU 1z, and transmits data generated by the CPU 1z to other devices via the communication network 9z.

The CPU 1z controls an output device such as a display or a printer, and an input device such as a keyboard or a mouse via the input/output I/F 6z. The CPU 1z acquires data from the input device via the input/output I/F 6z. Further, the CPU 1z outputs the generated data to the output device via the input/output I/F 6z.

The media I/F 7z reads a program or data stored in a recording medium 8z and outputs the data to the CPU 1z via the RAM 2z. The CPU 1z loads the program from the recording medium 8z on the RAM 2z via the media I/F 7z and executes the loaded program. The recording medium 8z is an optical recording medium such as a DVD (Digital Versatile Disc) or a PD (Phase change rewritable Disk), a magneto-optical recording medium such as an MO (Magneto Optical disk), a magnetic recording medium, a semiconductor memory, or the like.

For example, in a case where the computer z serves as the NEs 1 to 4 and the CTL 100, the CPU 1z of the computer z implements the functions of each unit by executing the program loaded on the RAM 2z. When executing the program, the data stored in the HDD 4z or the like is used. The CPU 1z of the computer z reads these programs from the recording medium 8z and executes them, but as another example, these programs may be acquired from another device via the communication network 9z.

### <Effects>

As stated above, the transfer system according to the present invention includes a transfer device (NE 2) that outputs packets to a plurality of physical lines (L1 to Ln); and a transfer control device (CTL 100), in which the transfer device includes: a measurement unit (22) configured to measure performance of network requirements specified by given service for each physical line; and a selection unit (23) configured to select the physical line at which the measured performance is maximized from among the plurality of physical lines, and in which the transfer control device includes: an instruction unit (102) configured to receive an advertisement including route information (d1) for selecting a route for each requirement from the transfer device, and to offer a route instruction using the route information (d3 substantially equivalent to d1) to a service for which the requirement is specified.

Therefore, in the transfer control for the service for which the latency requirement is specified, the transfer device (NE 2) measures performance of each physical line and controls a route of each physical line instead of the transfer control device (CTL 100). Accordingly, the processing previously executed by the transfer control device is offloaded to the transfer device, and it is possible to reduce the measurement load of the transfer control device and control load of the transfer control device due to latency fluctuation. In other words, it is possible to reduce stress of a transfer control device for performing route control. As a result, the performance measurement process and the route control process based on the measurement results are distributed to the transfer control device and the transfer device, and the control load is not applied at one point only. Therefore, a large-scale network can be constructed. Scale performance can be improved due to increased number of physical lines. Further, as the processing is distributed, response performance of a flow from measurement to route control can be improved.

The transfer device (NE2) according to the present embodiment is a transfer device which is capable of outputting packets to a plurality of physical lines (L1 to Ln), and includes a measurement unit (22) configured to measure performance of network requirements specified by a given service for each physical line; and a selection unit (23) configured to select the physical line at which the measured performance is maximized from among the plurality of physical lines.

Thus, it is not required for the transfer control device to measure the performance of each physical line and to control the route of each physical line unit. Accordingly, it is possible to reduce stress of a transfer control device for performing route control.

In the transfer device according to the present embodiment, the requirement is network latency. The measurement unit is configured to measure latency for each physical line by measuring a time from transfer of a measurement packet to a first adjacent transfer device to reception the measurement packet from a second adjacent transfer device using the measurement packet, wherein the measurement packet is transferred from the transfer device to the first adjacent transfer device and transits the transfer device, and is transferred to the second adjacent transfer device via the target physical line and received by the transfer device from the second adjacent transfer device via the target physical line.

According it is possible to measure latency for each physical line and offload the route control for each physical line to the transfer device.

The transfer control device (CTL 100) according to the present embodiment is a transfer control device includes an instruction unit (102) configured to receive an advertisement including route information (d1) for selecting a route for each requirement from a transfer device that outputs packets to a plurality of physical lines, and to offer a route instruction using the route information (d3 substantially equivalent to d1) to a service for which the requirement is specified.

Accordingly, it is possible to measure performance for each physical line and offload the route control for each physical line to the transfer device. Accordingly, it possible to reduce stress of a transfer control device performing route control.

### <Others>

(a) In the present embodiment, the CTL 100 receive an advertisement including the route information d1 from the NE 2 only, and gives the E2E route instruction with the requirement specified. However, the measurement results of the measurement unit 22 in the NE 2 may be advertised to the CTL 100, and the physical line having the maximum performance may be determined by the CTL 100.
(b) In a case where there are a plurality of physical lines L1 to Ln in the NE2→NE3 segment, the NE 3, which is an input target from the physical lines L1 to Ln, may advertise the route information to the CTL100 and measures performance for each requirement, or may select the physical line for each requirement according to the measurement results.
(c) A technology obtained by appropriately combining various technologies described in the present embodiment can be implemented.

### REFERENCE SIGNS LIST

1 to 4: NE (network element: transfer device)

21: Advertising unit

22: Measurement unit

23: Selection unit

100: CTL (controller: transfer control device)

101: Acquisition unit

102: Instruction unit

d1 to d3: Route information

1. A transfer system, comprising:
a transfer device configured to output one or more packets to a plurality of physical lines; and
a transfer control device,
wherein the transfer device includes:
a measurement unit, implemented using one or more computing devices, configured to measure performance of network requirements specified by a given service for each physical line of the plurality of physical lines; and
a selection unit, implemented using one or more computing devices, configured to select a physical line at which the measured performance is maximized from among the plurality of physical lines,
wherein the transfer control device includes:
an instruction unit, implemented using one or more computing devices, configured to:
receive, from the transfer device, route information for selecting a route for each network requirement, and
provide, to a service for which the network requirement is specified, a route instruction using the route information.

2. A transfer device that outputs packets to a plurality of physical lines, the device comprising:
a measurement unit, implemented using one or more computing devices, configured to measure performance of network requirements specified by a given service for each physical line of the plurality of physical lines; and
a selection unit, implemented using one or more computing devices, configured to select a physical line at which the measured performance is maximized from among the plurality of physical lines.

3. The transfer device according to claim 2,
wherein the requirement is network latency,
wherein the measurement unit is configured to measure latency for each physical line by measuring a time from transfer of a measurement packet to a first adjacent transfer device to reception of the measurement packet from a second adjacent transfer device using the measurement packet, and
wherein the measurement packet is transferred (i) from the transfer device to the first adjacent transfer device, and (ii) to the second adjacent transfer device via a target physical line, and received by the transfer device from the second adjacent transfer device via the target physical line.

4. A transfer control device, comprising:
an instruction unit, implemented using one or more computing devices, configured to:
receive, from a transfer device, route information for selecting a route for each network requirement, the transfer device configured to output one or more packets to a plurality of physical lines, and
provide, to a service for which the network requirement is specified, a route instruction using the route information.

5-8. (canceled)
